(19) United States
(12) Patent Application Publication
(10) Pub. No.: US 2025/0083732 A1
(43) Pub. Date: Mar. 13, 2025

(54) VARIABLE SPEED INTUITIVE ELECTRIC STEERING

(71) Applicant: Ariens Company, Brillion, WI (US)

(72) Inventor: Craig Siebert, Neenah, WI (US)

(21) Appl. No.: 18/720,426

(22) PCT Filed: Mar. 29, 2023
(86) PCT No.: PCT/US2023/065082

§ 371 Date: Jun. 14, 2024

(51) Int. Cl. B62D 1/12; B60L 15/20; B62D 11/04

(52) U.S. Cl. CPC B62D 1/12; B60L 15/20; B62D 11/04; B60L 2200/40

(57) ABSTRACT

Systems and methods for operating a motor-driven vehicle. One example system includes a handlebar configured to pivot about an axis, a position sensor for sensing a displacement of the handlebar, a first electric drive motor configured to drive a first wheel of the vehicle, a second electric drive motor configured to drive a second wheel of the vehicle, a first motor controller coupled to the position sensor and the first electric drive motor, and a second motor controller coupled to the position sensor and the second electric drive motor. The first motor controller is configured to receive a sensed displacement from the position sensor and control the first electric drive motor based on the sensed displacement. The second motor controller is configured to receive the sensed displacement from the position sensor and control the second electric drive motor based on the sensed displacement.

### CROSS-REFERENCE TO RELATED APPLICATIONS

The present application is related to and claims benefit under 35 U.S.C. § 119(e) from U.S. Provisional Patent Application Ser. No. 63/324,893, filed Mar. 29, 2022, entitled “VARIABLE SPEED INTUITIVE ELECTRIC STEERING,” the entire contents of which is incorporated herein by reference.

### BACKGROUND

Snow blowers and other motor-driven vehicles are steered by a user through the use of, among other things, a handlebar. With some snow blowers, the operator steers by pushing the handlebar to the right or left, causing the snow blower to steer to the left or right, respectively. Some snowblowers are steered by selectively engaging and disengaging power from a single drive motor to two drive wheels.

### SUMMARY

Systems and methods for variable speed intuitive electric steering are presented herein. As noted, some snowblowers are steered by selectively engaging and disengaging power from a drive motor to two drive wheels using clutches. Such methods allow for limited maneuverability. In a motor-driven vehicle with a dual electric drive motor configuration, the capability exists to adjust left and right wheel speed independently based on the desired direction of travel. Variable speed intuitive electric steering removes the need for operator intervention during steering and allows the vehicle to steer naturally during normal motion of the vehicle as the respective wheel speed and direction is automatically adjusted based on forces applied to the handlebar of the vehicle by the operator.

Embodiments and examples described herein relate to how controlling electric drive motors to produce the desired operation during maneuvering of a motor driven vehicle (such as a snowblower, a lawn mower, or a tractor) based on forces applied to the handlebar of the vehicle by an operator. As described herein, two independent electric drive motors allow for greater control and maneuverability than the standard single motor electric steer. Examples described herein deliver more control performance for the operator. This provides the operator with greater ability to maneuver the unit. Monitoring the angular position allows for continuous calculations to compete the desired wheel speed to achieve the desired direction and speed at all times. Such systems are also capable of robotic control operation.

One example provides a system for operating a motor-driven vehicle. The system includes a handlebar for steering the motor-driven vehicle, the handlebar configured to pivot about an axis, a position sensor for sensing a displacement of the handlebar, a first electric drive motor configured to drive a first wheel of the vehicle, a second electric drive motor configured to drive a second wheel of the vehicle, a first motor controller, and a second motor controller. The first motor controller is coupled to the position sensor and the first electric drive motor. The first motor controller is configured to receive a sensed displacement of the handlebar from the position sensor and control the first electric drive motor based on the sensed displacement. The second motor controller is coupled to the position sensor and the second electric drive motor. The second motor controller is configured to receive the sensed displacement of the handlebar from the position sensor and control the second electric drive motor based on the sensed displacement.

Another example provides a method for operating a motor-driven vehicle. The method includes determining a displacement for a handlebar of the motor-driven vehicle, the angular position being relative to an axis about which the handlebar is configured to pivot. The method includes controlling a first electric drive motor configured to drive a first wheel of the vehicle based on the displacement. The method includes controlling a second electric drive motor configured to drive a second wheel of the vehicle based on the displacement.

Other aspects of the invention will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments, examples, aspects, and features of concepts that include the claimed subject matter and explain various principles and advantages of those embodiments, examples, aspects, and features.

FIG. 1 is a diagram of a motor driven vehicle according to some examples.

FIG. 2 is a functional diagram of a system for implementing variable speed intuitive steering of the vehicle of FIG. 1 according to some examples.

FIG. 3 is a flowchart illustrating an example of the operation of the system of FIG. 2 according to some examples.

FIGS. 4A-4C illustrate aspects of the operation of the motor driver vehicle of FIG. 1 according to some examples.

FIG. 5 is a is a block diagram of the controller according to some examples.

FIG. 6 is a flowchart illustrating an example method of operating the system of FIG. 2 according to some examples.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of examples, aspects, and features illustrated.

In some instances, the apparatus and method components have been represented where appropriate by conventional symbols in the drawings, showing only those specific details that are pertinent to understanding the of various embodiments, examples, aspects, and features so as not to obscure the disclosure with details that will be readily apparent to those of ordinary skill in the art having the benefit of the description herein.

### DETAILED DESCRIPTION

Before any embodiments of the invention are explained in detail, it is to be understood that the examples presented herein are not limited in their application to the details of construction and the arrangement of components set forth in the following description or illustrated in the following drawings. The invention is capable of other embodiments and of being practiced or of being carried out in various ways. For example, while the systems and methods described herein are described in terms of a snowblower, it should be understood that such systems and methods may be applied to other systems such as lawnmowers, tractors, and the like.

It should be noted that a plurality of hardware and software-based devices, as well as a plurality of different structural components may be utilized to implement the embodiments described herein or portions thereof. In addition, it should be understood that embodiments described herein may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects described herein may be implemented in software (stored on non-transitory computer-readable medium) executable by one or more processors. As such, it should be noted that a plurality of hardware and software-based devices, as well as a plurality of different structural components may be used to implement the embodiments described herein. For example, “controller,” “control unit,” “control module,” and “control assembly” described in the specification may include one or more processors, one or more memory modules including non-transitory computer-readable medium, one or more input/output interfaces, and various connections (e.g., a system bus) connecting the components.

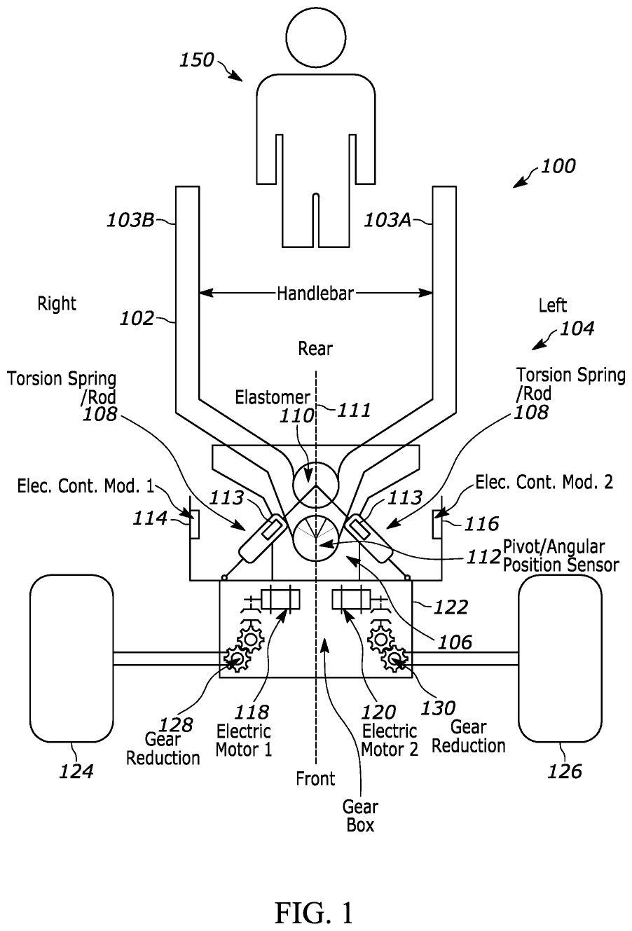

Systems and methods described herein relate to how electric drive motors are driven to produce the desired operation during maneuvering of a motor driven vehicle (e.g., a snowblower, a lawn mower, or a tractor), based on movement of a handlebar of the vehicle. FIG. 1 is a diagram of an example motor driven vehicle 100, viewed from front to back (in the illustrated embodiment, a snowblower). The vehicle 100 includes a handlebar 102, which is coupled to a chassis 104 at a single pivot point 106. The handlebar 102 is a unitary handlebar including a left handle 103A and a right handle 103B. In alternative embodiments, the handlebar 102 is comprised of two handles or grips, which each attach to the chassis 104 at its own pivot point. The handlebar 102 is configured to pivot about at least one axis of the pivot point 106 (e.g., a vertical axis). The handlebar 102 is torsion controlled to a center position, for example, using a torsion controller (e.g., the torsion/spring rods 108 and an elastomer structure 110). The torsion/spring rods 108 and the elastomer structure 110 are configured to bias the handlebar 102 to a substantially centered position (e.g., parallel with a longitudinal axis 111 of the vehicle 100) in the absence of pressure applied by an operator 150. The torsion/spring rods 108 and the elastomer structure 110 are further configured to enable the handlebar 102 to move laterally (e.g., side to side) in response to pressure applied on the handlebar 102 by an operator 150 of the vehicle 100. The biasing of the handlebar 102 causes the handlebar 102 to move variably toward the substantially centered position about the axis in response to changes in applied pressure.

In some embodiments, in which the pivot point 106 enables movement about more than one axis, the torsion/spring rods 108 and the elastomer structure 110 are further configured to enable the handlebar 102 to move along multiple axes in response to pressure applied on the handlebar 102 by an operator 150 of the vehicle 100 and to bias the handlebar 102 to return to a substantially centered position in the absence of applied pressure.

The vehicle 100 includes one or more position sensors for sensing a displacement of the handlebar (e.g., laterally in response to pressure applied on the handlebar 102 by an operator 150 of the vehicle 100).

In some embodiments, the position sensor is an angular position sensor 112 positioned to sense displacement of the handlebar by sensing the angular movement of the handlebar 102 relative to the pivot point 106 (e.g., in degrees expressed positively for one direction and negatively for the opposite direction). As described herein, the sensor 112 sends either analog or digital signals to one or more electronic controllers (e.g., the first motor controller 114 and the second motor controller 116). In some aspects, the sensor 112 is configured to output signals indicating an angular position of the handlebar 102. In some aspects, the sensor 112 is configured to output signals indicating movement of the handlebar 102, from which an electronic controller is able to calculate an angular position for the handlebar 102.

In some embodiments, the position sensor is a linear displacement sensor positioned to sense displacement of the handlebar (e.g., in millimeters or another unit of distance expressed positively for one direction and negatively for the opposite direction). For example, as illustrated in FIG. 1, the vehicle 100 may include linear translation sensors 113, positioned to sense a displacement (e.g., a lateral displacement) of the handlebar 102. In some embodiments, the linear translation sensors are positioned on or near the torsion/spring rods 108 to sense displacement of the torsion/spring rods 108, which is translated into a displacement for the handlebar. The sensors 113 send either analog or digital signals to one or more electronic controllers (e.g., the first motor controller 114 and the second motor controller 116). In some aspects, the sensors 113 are configured to output signals indicating a linear translation of the handlebar 102. In some aspects, the sensors 113 are configured to output signals, from which an electronic controller is able to calculate the linear translation for the handlebar 102.

The first motor controller 114 is electrically coupled to and configured to control a first electric drive motor 118, as described herein. The second motor controller 116 is electrically coupled to and configured to control a second electric drive motor 120, as described herein. In the embodiment illustrated, the first and second electric drive motors are positioned in a gear box 122. The first electric drive motor 118 is coupled to and configured to drive a first wheel 124, as described herein. The second electric drive motor 120 is coupled to and configured to drive a second wheel 126, as described herein. In the illustrated embodiment, the first and second electric drive motors 118, 120 are coupled to the first and second wheels 124, 126 by a first reduction gear 128 and a second reduction gear 130, respectively.

In some embodiments, the gear box 122 includes electromechanical clutches (not shown) positioned between the first and second electric drive motors 118, 120 and the first and second wheels 124, 126, respectively, to assist in freewheeling of the vehicle 100. In such embodiments, the controller may include clutch outputs to control each clutch individually. In some instances, one or more electronic controllers of the vehicle 100 are configured to default into freewheel mode (i.e., both electromechanical clutches disengaged). This improves operator comfort because pushing a vehicle that has an electric drive motor engaged to a gear reduction can be difficult on the operator. The electromechanical clutches allow the vehicle 100 to freewheel whenever they are disengaged. If the required the force to drive the motor and gear boxes was low enough that the operator force to push an unpowered unit was reduced to a desired level, then the electromechanical clutches may not be included.

In some embodiments, the vehicle 100 includes a vehicle control module or another central electronic controller, which may perform some aspects of the methods described herein (e.g., interfacing with the sensors 112, 113 and sending instructions based on the sensor readings to the motor controllers).

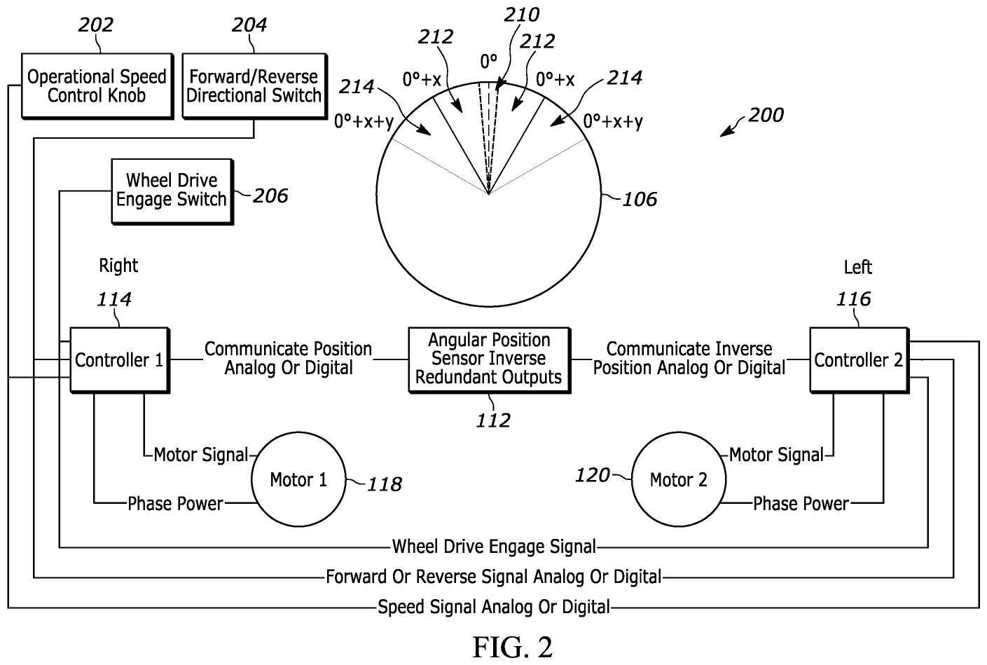

FIG. 2 illustrates an example system 200 for implementing variable speed intuitive steering of the vehicle 100. In addition to the sensor 112, the first and second motor controllers 114, 116, and the first and second electric drive motors 118, 120, the system 200 includes an operational speed selector 202, a forward/reverse directional selector 204, and a wheel drive engage selector 206, each included in the vehicle 100. Each of the operational speed selector 202, the forward/reverse directional selector 204, and the wheel drive engage selector 206 is a suitable analog or digital selection device, which provides inputs to both the first motor controller 114 and the second motor controller 116. The selection devices may be a physical switch, knob, slider, button, or other suitable device providing control input to the first motor controller 114 and the second motor controller 116. In some embodiments, one or more of the selection devices may be virtual (e.g., a graphical user interface element presented on one or more electronic displays by an electronic control module (ECM), vehicle control module (VCM), or similar electronic control unit). In some embodiments, the selection devices (either physical or virtual) may provide their signals to the first and second motor controllers 114, 116 via a communication bus (e.g., a CAN bus) or through one or more intervening electronic controllers (e.g., a VCM).

In the embodiment illustrated in FIG. 2, the sensor 112 is an angular position sensor. The first and second motor controllers 114, 116 include inputs (e.g., an active high or active low input) for receiving forward/reverse position indicator signals from the forward/reverse directional selector 204, which indicate whether the vehicle should move in a forward or reverse direction. The first and second motor controllers 114, 116 each further include a speed input for receiving a signal indicating a desired speed for the vehicle 100 from the operational speed selector 202. In some embodiments, the speed input is an analog speed input (e.g., receiving an analog signal via a hall effect sensor or potentiometer of the operational speed selector 202). In some embodiments, the speed input receives a digital signal, indicative of a requested vehicle speed. The first and second motor controllers 114, 116 each further include a wheel drive engage input (e.g., an active high or active low input) for receiving wheel drive engagement indicator signals from the wheel drive engage selector 206, which indicate whether the motors are allowed to engage the wheels. In some embodiments, the first and second motor controllers 114, 116 will not command any speed for the first and second electric drive motors 118, 120 unless a wheel drive engagement signal is active.

The first and second motor controllers 114, 116 each further include a handlebar position input, which may be analog or digital, for receiving the sensed position of the handlebar 102 from the sensor 112. In the example illustrated in FIG. 2, the sensor 112 is an angular position sensor. During operation of the vehicle 100, as the operator manipulates (e.g., by applying lateral forces) the handlebar 102, the first and second motor controllers 114, 116 determine an angular position for the handlebar 102 sensed by the sensor 112. In some embodiments, the angular position is received from the sensor 112 continuously. In some embodiments, the angular position is determined periodically. In some embodiments, the angular position is sampled regularly from a signal received from the sensor 112 and may be averaged to determine the angular position of the handlebar 102. In some aspects, angular position data is received and normalized by the first and second motor controllers 114, 116. In some aspects, the sensor 112 provides its signals to the first and second motor controllers 114, 116 via a communication bus (e.g., a CAN bus) or through one or more intervening electronic controllers (e.g, a VCM). In some configurations, an intervening processor (e.g., a VCM) receives sensor signals from the sensor 112 and outputs angular position data to the first and second motor controllers 114, 116.

In FIG. 2, the pivot point 106 is schematically illustrated to show angular position bands, which represent ranges for the position of the handlebar 102 during operation of the vehicle 100. As described herein, the first and second motor controllers 114, 116 are configured to control the first and second electric drive motors 118, 120 to effect movement and steering of the vehicle 100 based on which angular position band the handlebar 102 is in. As illustrated in FIG. 2, in some embodiments, a dead band 210 is defined around the zero position (between the dashed lines on either side of the zero position). While the handlebar 102 is in the dead band, no adjustments are made to the wheel speed. The dead band (also referred to as a neutral band) is a relatively narrow angular position band, which prevents minor variations from the zero position resulting in steering movements. This allows an operator to steer in a straight line without having to hold the handlebar 102 exactly at the center (zero) position. This also prevents jostling or other movements caused by the operation of the machine (e.g., caused by movement over uneven ground) from acting as steering inputs.

As illustrated in FIG. 2, there are two more bands located on either side of the zero point: a first band 212 from the neutral band to the 0°+x position, and a second band 214 from the 0°+x position to the 0°+x+y position. The values of x and y are determined based on characteristics (e.g., size, shape, weight) of the vehicle 100, a desired steering responsiveness level for the vehicle 100, and other factors.

As illustrated in FIG. 2, the first and second bands 212, 214 are duplicated on either side of the zero point. The first and second motor controllers 114, 116 are configured to control the first and second electric drive motors 118, 120 to effect steering of the vehicle 100 based on which angular position band the handlebar 102 is in, the forward or reverse direction of the vehicle 100, and the selected operational speed of the vehicle 100. Steering is effected as described herein, making reference to controlling the speed and/or direction of the “inside wheel” and the “outside wheel.” Inside and outside wheels are labeled such relative to the turn being requested. For example, when the operator of the vehicle shifts the handlebar 102 to the left and the vehicle 100 is moving in the forward or reverse direction, the operator is attempting to turn the front of the vehicle to the right. In this example, the right wheel is the inside wheel, and the left wheel is the outside wheel. In another example, when the operator of the vehicle shifts the handlebar to the right and the vehicle 100 is moving in the forward or reverse direction, the operator is attempting to turn the front of the vehicle to the left. In this example, the left wheel is the inside wheel, and the right wheel is the outside wheel.

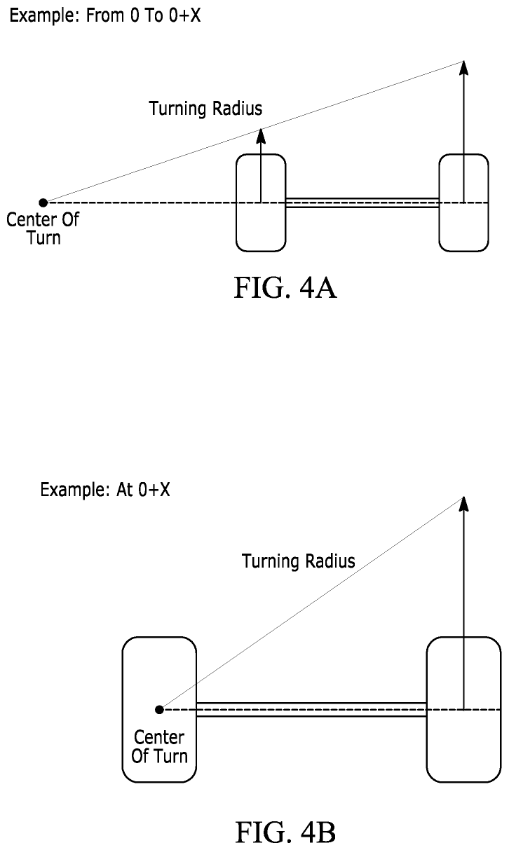

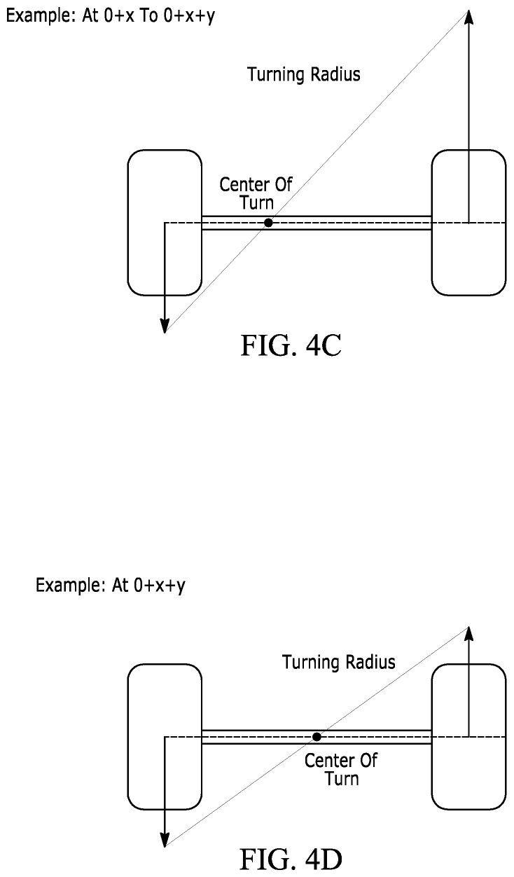

When the handlebar 102 is in the first band 212, the motor controller for the inside wheel's electric drive motor slows the inside wheel of the turn proportional to the angular position, while the motor controller for the outside wheel's electric drive motor maintains the speed of the outside wheel, set by the operational speed signal and the forward/reverse direction (e.g, while in the reverse direction, the speed may be 50% of the speed called for during the forward direction). (See FIG. 4A)

When the handlebar 102 is at or passing through the 0°+x position in an increasing manner, the motor controller for the inside wheel's electric drive motor stops the inside wheel of the turn and transitions from spinning in the direction of travel to spinning opposite the direction of travel. (See FIG. 4B)

When the handlebar 102 is in the second band 214, the motor controller for the inside wheel's electric drive motor ramps the speed for the inside wheel to the maximum speed for that direction based on the speed set by the operational speed signal, proportional to the angular position, while the motor controller for the outside wheel's electric drive motor adjusts a speed multiplier proportional to the angular position up to the maximum vehicle speed set by the operational speed signal. (See FIG. 4C) When the outside wheel is spinning at the maximum speed, this calculation does not influence outside wheel speed.

As illustrated in FIG. 4D, when the handlebar 102 is at the edge of the second band 214 (i.e., at the 0+x+y position), the motor controllers operate the motors to spin at equal speeds in opposite directions, effecting a zero-turn radius turn in the appropriate direction.

It should be noted that, while FIGS. 4A-4D depict (by way of example) left turns only, embodiments described herein are applicable to effect either left or right turns.

In alternative embodiments, the system 200 includes one or more linear translation sensors 113 in lieu of or in addition to the angular position sensor 112. In such embodiments, control may be achieved by using bands defined by, for example, ranges of handlebar linear translation left or right rather than an angular position.

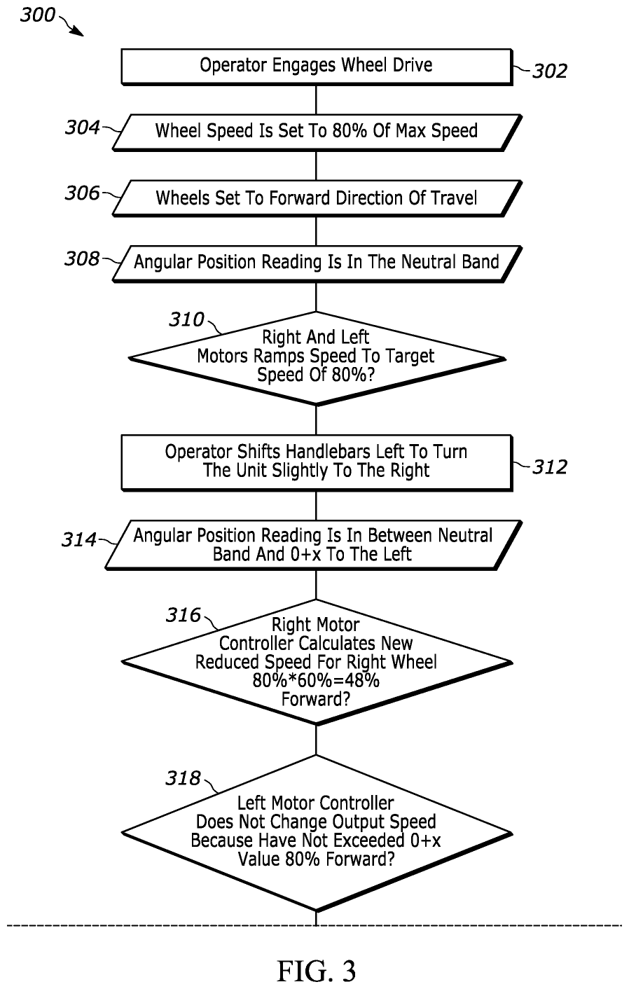

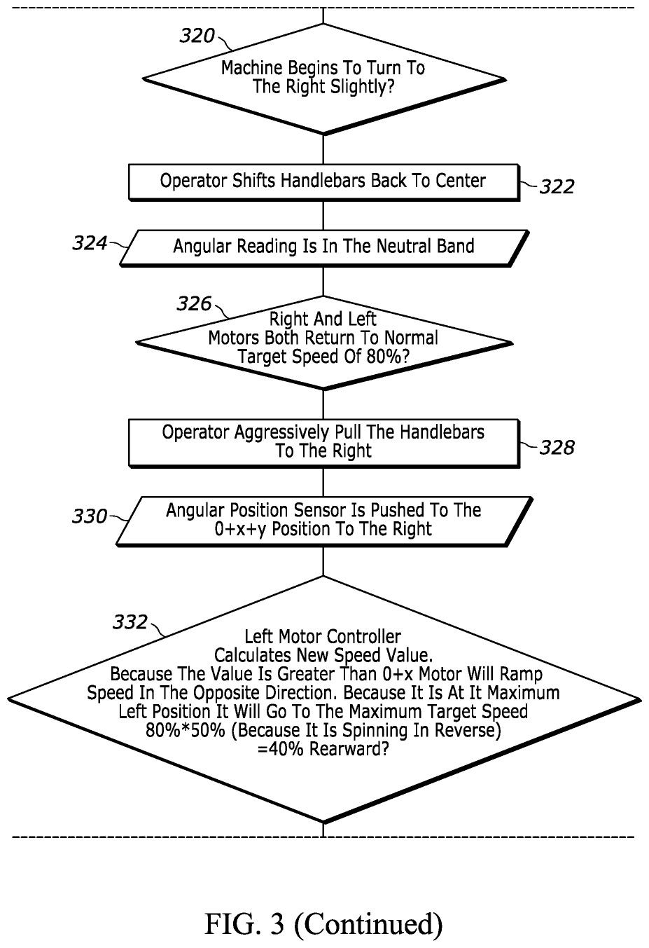

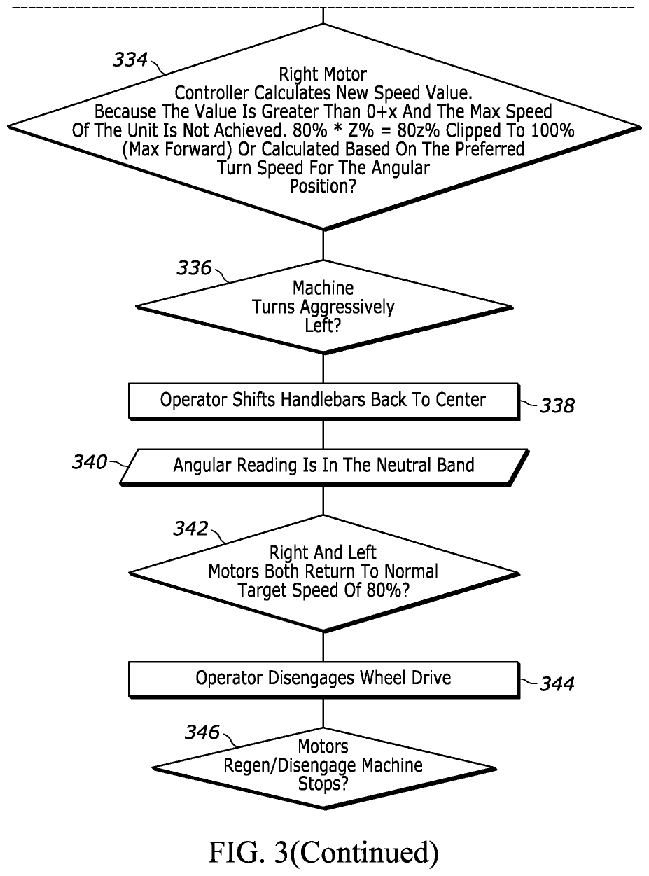

FIG. 3 is a flowchart 300 illustrating an example operation of the system 200 using an angular position sensor. It will be appreciated that the operations illustrated in FIG. 3 may be modified or performed differently than the specific example provided while still falling within the scope of the embodiments described herein.

At block 302, the first and second motor controllers 114, 116 receive wheel drive engagement indicator signals from the wheel drive engage selector 206 as the operator of the vehicle 100 engages the wheel drive.

At block 304, the first and second motor controllers 114, 116 receive a requested speed from the operational speed selector 202 as the operator of the vehicle 100 sets the operational speed selector to 80% of maximum.

At block 306, the first and second motor controllers 114, 116 receive a forward direction indicator signal from the forward/reverse directional selector 204 as the operator of the vehicle 100 selects the forward direction of travel.

At block 310, in response to receiving these signals (at blocks 302-306), the first and second motor controllers 114, 116 control the first and second motor controllers 114, 116 to ramp up to a target speed of 80% of maximum, propelling the vehicle 100 in a forward direction at 80% of maximum speed. In the absence of any steering inputs, this movement will be in a substantially straight line.

At block 312, the operator 150 shifts the handlebar 102 left to turn the vehicle 100 to the right.

At block 314, the angular position sensor 112 detects the angular position of the handlebar 102 in the first band. The angular position is communicated to the first and second motor controllers 114, 116.

At block 316, in response to receiving the angular position signal, the first (right) motor controller 114 calculates a new reduced speed for the right wheel 124 (e.g., 80%*60%=48% forward).

At block 318, in response to receiving the angular position signal, the second (left) motor controller 116, does not change the speed for the left wheel 126.

At block 320, the first (right) motor controller 114 controls the first (right) electric drive motor 118 to move the first (right) wheel 124 at the calculated speed and direction (48% forward), and the second (left) motor controller 116 controls the second (left) electric drive motor 120 to move the second (left) wheel 126 at the requested speed and direction (80% forward). As illustrated in FIG. 4A, this results in a turning radius that causes the vehicle 100 to turn slightly to the right.

At block 322, the operator returns the handlebar 102 to the center position.

At block 324, the angular position sensor 112 detects the angular position of the handlebar 102 in the neutral band. The angular position is communicated to the first and second motor controllers 114, 116.

At block 326, in response to receiving the angular position signal, the first and second motor controllers 114, 116 control the first and second electric drive motors 118, 120 to operate at the requested speed, propelling the vehicle 100 in a forward direction at 80% of maximum speed in a substantially straight line.

At block 328, the operator 150 shifts the handlebar 102 right, applying more force than the previous turn, to turn the vehicle 100 to the left.

At block 330, the angular position sensor 112 detects the angular position of the handlebar 102 in the second band (0°+x+y (to the right of center)). The angular position is communicated to the first and second motor controllers 114, 116.

At block 332, in response to receiving the angular position signal, the second (left) motor controller 116 calculates a new speed and direction for the left wheel 126 (e.g., 80%*50%=40% rearward).

At block 334, in response to receiving the angular position signal, the first (right) motor controller 114, calculates a new speed value for the right wheel 124. Because the value is greater than 0°+x and the max speed of the unit has not been reached, the speed is set to 100% (max) forward or is calculated based on a predetermined preferred turn speed for the angular position.

At block 336, the first (right) motor controller 114 controls the first (right) electric drive motor 118 to move the right wheel 124 at the calculated speed and direction (100% forward), and the second (left) motor controller 116 controls the second (left) electric drive motor 120 to move the left wheel 126 at the calculated speed and direction (40% rearward). As illustrated in FIG. 4D, this results in a turning radius that causes the vehicle 100 to turn aggressively (sharply) to the left.

At block 338, the operator returns the handlebar 102 to the center position.

At block 340, the angular position sensor 112 detects the angular position of the handlebar 102 in the neutral band. The angular position is communicated to the first and second motor controllers 114, 116.

At block 342, in response to receiving the angular position signal, the first and second motor controllers 114, 116 control the first and second electric drive motors 118, 120 to operate at the requested speed, propelling the vehicle 100 in a forward direction at 80% of maximum speed in a substantially straight line.

At block 344, the first and second motor controllers 114, 116 receive wheel drive disengagement indicator signals from the wheel drive engage selector 206 as the operator of the vehicle 100 disengages the wheel drive and the vehicle 100 comes to a stop (at block 346).

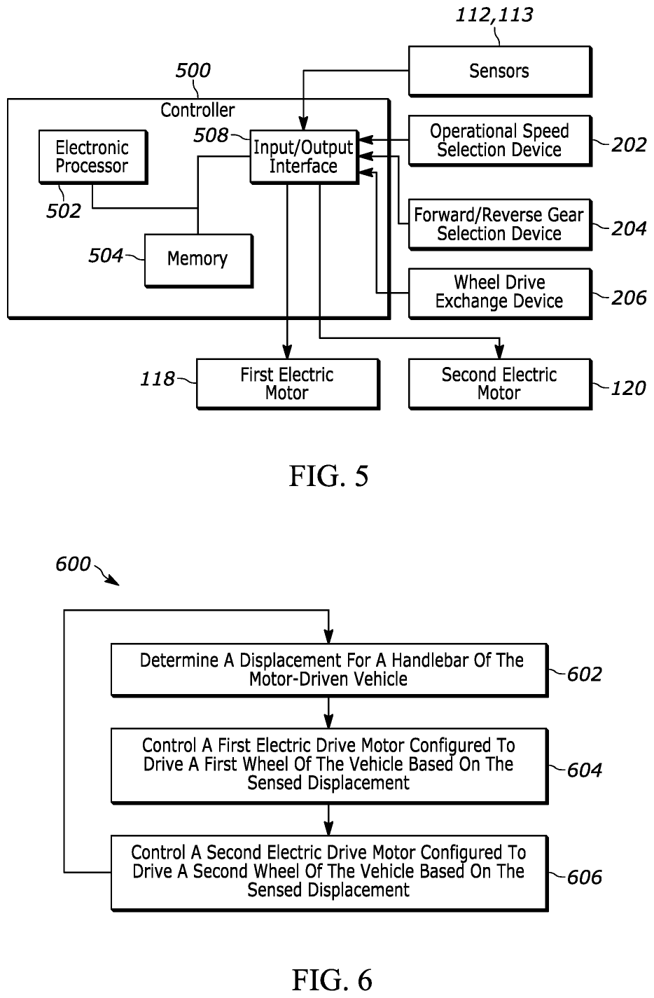

FIG. 5 is a block diagram of an example electronic controller 500 according to some examples. The first and second motor controllers 114, 116 may include similar components and operate similarly to the electronic controller 500.

In the example illustrated, the controller 500 includes an electronic processor 502 (e.g., a microprocessor, application-specific integrated circuit (ASIC), or another suitable electronic device), a memory 504 (e.g., a non-transitory, computer-readable storage medium), a communication interface 506, and an input/output interface 508. The electronic processor 502, the memory 504, the communication interface 506, and the input/output interface 508 communicate over one or more control and/or data buses (for example, a communication bus). The use of control and data buses for the interconnection between and exchange of information among the various modules and components would be apparent to a person skilled in the art in view of the description provided herein. FIG. 5 illustrates only one example embodiment of the controller 500. The controller 500 may include fewer or additional components and may perform functions other than those explicitly described herein.

In some embodiments, the electronic processor 502 is implemented as a microprocessor with separate memory, for example, the memory 504. In other embodiments, the electronic processor 502 may be implemented as a microcontroller (with memory on the same chip). In other embodiments, the electronic processor 502 may be implemented using multiple processors. In addition, the electronic processor 502 may be implemented partially or entirely as, for example, a field-programmable gate array (FPGA), and application specific integrated circuit (ASIC), and the like and the memory may not be needed or be modified accordingly.

In the example illustrated, the memory 504 includes non-transitory, computer-readable memory that stores instructions that are received and executed by the electronic processor 502 to carry out functionality of the controller 500 described herein. The memory 504 may include, for example, a program storage area and a data storage area. The program storage area and the data storage area may include combinations of different types of memory, for example, read-only memory and random-access memory.

The input/output interface 508 receives input from one or more components of the controller 500 and/or the vehicle 100 (e.g., input devices actuated by an operator of the vehicle 100—the operational speed selector 202, the forward/reverse directional selector 204, the wheel drive engage selector 206, and the like) and provides output to one or more components of controller 500 and the vehicle 100. The input/output interface may also receive signals from one or more sensors (e.g., the sensors 112, 113) utilized by the electronic processor 502 to determine one or more states of one or more components of the vehicle 100. In some instances, the input/output interface 508 is electrically coupled to the first and second electric drive motors 118, 120, and controls (along with the electronic processor 502) the operation of the first and second electric drive motors 118, 120 as described herein.

FIG. 6 illustrates an example method 600 for operating a motor-driven vehicle (e.g., the vehicle 100). It will be appreciated that the method 600 may be modified or performed differently than the specific example provided while still falling within the scope of the embodiments described herein.

At block 602, the method determines a displacement for a handlebar of the motor-driven vehicle. For example, as described herein, one or more controllers (e.g., the first and second motor controllers 114, 116) receive angular position data for the handlebar from the sensor 112. In another example, one or more controllers (e.g., the first and second motor controllers 114, 116) receive linear translation data for the handlebar from one or both of the sensors 113.

At block 604, the method controls a first electric drive motor configured to drive a first wheel of the vehicle based on the sensed displacement. For example, as described herein, the first motor controller 114 may determine an angular position band based on the angular position and determine a direction and speed for the first electric drive motor 118 based on the angular position band. In another example, the first motor controller 114 may determine a linear translation band based on the linear translation and determine a direction and speed for the first electric drive motor 118 based on the linear translation band.

At block 606, the method controls a second electric drive motor configured to drive a second wheel of the vehicle based on the angular position. For example, as described herein, the second motor controller 116 may determine an angular position band based on the angular position and determine a direction and speed for the second electric drive motor 120 based on the angular position band. In another example, the second motor controller 116 may determine a linear translation band based on the linear translation and determine a direction and speed for the second electric drive motor 120 based on the linear translation band.

In some aspects, the speed of the electric drive motors is based further on a requested speed received from operational speed selector of the vehicle.

In some aspects, the speed and direction of the electric drive motors is based further on a direction for the vehicle received from a directional selector of the vehicle.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Unless explicitly stated otherwise, each numerical value and range should be interpreted as being approximate as if the word “about” or “approximately” preceded the value or range.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Unless otherwise specified herein, in addition to its plain meaning, the conjunction “if” may also or alternatively be construed to mean “when” or “upon” or “in response to determining” or “in response to detecting,” which construal may depend on the corresponding specific context. For example, the phrase “if it is determined” or “if [a stated condition] is detected” may be construed to mean “upon determining” or “in response to determining” or “upon detecting [the stated condition or event]” or “in response to detecting [the stated condition or event].”

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately.” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The following paragraphs provide various examples of the embodiments disclosed herein.

Example 1 is a system for operating a motor-driven vehicle. The system comprises a handlebar for steering the motor-driven vehicle, the handlebar configured to pivot about an axis, a position sensor for sensing a displacement of the handlebar, a first electric drive motor configured to drive a first wheel of the vehicle, and a second electric drive motor configured to drive a second wheel of the vehicle, a first motor controller coupled to the position sensor and the first electric drive motor, and a second motor controller coupled to the position sensor and the second electric drive motor. The first motor controller is configured to receive a sensed displacement of the handlebar from the position sensor. The first motor controller is configured to control the first electric drive motor based on the sensed displacement. The second motor controller is configured to receive the sensed displacement of the handlebar from the position sensor. The second motor controller is configured to control the second electric drive motor based on the sensed displacement.

Example 2 may include the subject matter of Example 1 and may further specify that the first motor controller is configured to determine a direction for the first electric drive motor and a speed for the first electric drive motor based on the sensed displacement. Example 2 may also specify that the second motor controller is configured to determine a direction for the second electric drive motor and a speed for the second electric drive motor based on the sensed displacement.

Example 3 may include the subject matter of Example 2 and may further specify that the position sensor is an angular position sensor, and the sensed displacement is an angular position of the handlebar.

Example 4 may include the subject matter of Example 3 and may further specify that the first motor controller is configured to determine an angular position band based on the angular position and determine the direction for the first electric drive motor and the speed for the first electric drive motor based on the angular position band. Example 2 may also specify that the second motor controller is configured to determine the angular position band based on the angular position and determine the direction for the second electric drive motor and the speed for the second electric drive motor based on the angular position band.

Example 5 may include the subject matter of Example 2 and may further specify that the position sensor is a linear translation sensor, and the sensed displacement is a linear translation of the handlebar.

Example 6 may include the subject matter of Example 5 and may further specify that the first motor controller is configured to determine a linear translation band based on the linear translation and determine the direction for the first electric drive motor and the speed for the first electric drive motor based on the linear translation band. Example 6 may also specify that the second motor controller is configured to determine the linear translation band based on the linear translation and determine the direction for the second electric drive motor and the speed for the second electric drive motor based on the linear translation band.

Example 7 may include the subject matter of any of Examples 2-6 and may further specify that the system comprises an operational speed selector coupled to the first and second motor controllers. Example 7 may also specify that the first motor controller is configured to receive a requested speed from the operational speed selector and determine the speed for the first electric drive motor based on the requested speed. Example 7 may also specify that the second motor controller is configured to receive the requested speed from the operational speed selector and determine the speed for the second electric drive motor based on the requested speed.

Example 8 may include the subject matter of any of Examples 2-7 and may further specify that the system comprises a directional selector coupled to the first and second motor controllers. Example 8 may also specify that the first motor controller is configured to receive a direction from the directional selector and determine the speed for the first electric drive motor and the direction for the first electric drive motor based on the direction. Example 8 may also specify that the second motor controller is configured to receive the direction from the directional selector and determine the speed for the second electric drive motor and the direction for the second electric drive motor based on the direction.

Example 9 may include the subject matter of any of Examples 1-8 and may further specify that the system comprises a torsion controller coupled between the handlebar and a chassis of the vehicle. The torsion controller is configured to bias the handlebar to a centered position relative to the axis.

Example 10 may include the subject matter of any of Examples 1-9 and may further specify that the handlebar includes a first handle and a second handle, and the first handle and the second handle are configured to pivot about the same axis.

Example 11 may include the subject matter of any of Examples 1-10 and may further specify that the axis is either a horizontal axis or a vertical axis.

Example 12 may include the subject matter of any of Examples 1-11 and may further specify that the first handle is configured to pivot about a first axis and the second handle is configured to pivot about a second axis different from the first axis.

Example 13 is a method for operating a motor-driven vehicle. The method includes determining a displacement for a handlebar of the motor-driven vehicle. The method further includes controlling a first electric drive motor configured to drive a first wheel of the vehicle based on the displacement. The method further includes controlling a second electric drive motor configured to drive a second wheel of the vehicle based on the displacement.

Example 14 may include the subject matter of Example 13 and may further include controlling the first electric drive motor includes determining a direction for the first electric drive motor and a speed for the first electric drive motor based on the displacement. Example 14 may further include controlling the second electric drive motor includes determining a direction for the second electric drive motor and a speed for the second electric drive motor based on the displacement.

Example 15 may include the subject matter of Example 14 and may further specify that determining a displacement for a handlebar of the motor-driven vehicle includes determining an angular position for the handlebar, the angular position being relative to an axis about which the handlebar is configured to pivot.

Example 16 may include the subject matter of Example 15 and may further include determining an angular position band based on the angular position. Example 16 may further include determining the direction for the first electric drive motor and the speed for the first electric drive motor based on the angular position band. Example 16 may further include determining the direction for the second electric drive motor and the speed for the second electric drive motor based on the angular position band.

Example 17 may include the subject matter of Example 14 and may further specify that determining a displacement for a handlebar of the motor-driven vehicle includes determining a linear translation of the handlebar.

Example 18 may include the subject matter of Example 17 and may further include determining a linear translation band based on the linear translation. Example 18 may further include determining the direction for the first electric drive motor and the speed for the first electric drive motor based on the linear translation band. Example 18 may further include determining the direction for the second electric drive motor and the speed for the second electric drive motor based on the linear translation band.

Example 19 may include the subject matter of any of Examples 14-18 and may further include receiving a requested speed from an operational speed selector of the vehicle. Example 19 may further include determining the speed for the first electric drive motor based on the requested speed. Example 19 may further include determining the speed for the second electric drive motor based on the requested speed.

Example 20 may include the subject matter of any of Examples 14-19 and may further include receiving a direction for the vehicle from a directional selector of the vehicle. Example 20 may further include determining the speed for the first electric drive motor and the direction for the first electric drive motor based on the direction. Example 20 may further include determining the speed for the second electric drive motor and the direction for the second electric drive motor based on the direction.

Example 21 may include one or more non-transitory computer readable media having instructions thereon that, when executed by one or more electronic controllers, cause the controllers to perform the subject matter of any of Examples 13-20.

Example 22 is a system for operating a motor-driven vehicle. The system comprises a handlebar for steering the motor-driven vehicle, the handlebar configured to pivot about an axis, a position sensor for sensing a displacement of the handlebar, a first electric drive motor configured to drive a first wheel of the vehicle, and a second electric drive motor configured to drive a second wheel of the vehicle, and an electronic controller coupled to the position sensor, the first electric drive motor, and the second electric drive motor. The electronic controller is configured to receive a sensed displacement of the handlebar from the position sensor. The electronic controller is further configured to control the first electric drive motor based on the sensed displacement. The electronic controller is further configured to receive the sensed displacement of the handlebar from the position sensor. The electronic controller is further configured to control the second electric drive motor based on the sensed displacement.

Example 23 may include the subject matter of Example 22 and may further specify that the electronic controller is configured to determine a direction for the first electric drive motor, a speed for the first electric drive motor, a direction for the second electric drive motor, and a speed for the second electric drive motor based on the sensed displacement.

Example 24 may include the subject matter of Example 22 and may further specify that the position sensor is an angular position sensor, and the sensed displacement is an angular position of the handlebar.

Example 25 may include the subject matter of Example 24, and may further specify that the electronic controller is configured to determine an angular position band based on the angular position, and determine the direction for the first electric drive motor, the speed for the first electric drive motor, the direction for the second electric drive motor, and the speed for the second electric drive motor based on the angular position band.

Example 26 may include the subject matter of Example 23 and may further specify that the position sensor is a linear translation sensor, and the sensed displacement is a linear translation of the handlebar.

Example 27 may include the subject matter of Example 26, and may further specify that the electronic controller is configured to determine a linear translation band based on the linear translation, and determine the direction for the first electric drive motor, the speed for the first electric drive motor, the direction for the second electric drive motor, and the speed for the second electric drive motor based on the linear translation band.

Example 28 may include the subject matter of any of Examples 23-27 and may further specify that the system comprises an operational speed selector coupled to the electronic controller. Example 28 may also specify that the electronic controller is configured to receive a requested speed from the operational speed selector and determine the speed for the first electric drive motor and the speed for the second electric drive motor based on the requested speed.

Example 29 may include the subject matter of any of Examples 23-28 and may further specify that the system comprises a directional selector coupled to the electronic controller. Example 29 may also specify that the electronic controller is further configured to receive a direction from the directional selector and determine the speed for the first electric drive motor, the direction for the first electric drive motor, the speed for the second electric drive motor, and the direction for the second electric drive motor based on the direction.

Example 30 may include the subject matter of any of Examples 22-29 and may further specify that the system comprises a torsion controller coupled between the handlebar and a chassis of the vehicle. The torsion controller is configured to bias the handlebar to a centered position relative to the axis.

Example 31 may include the subject matter of any of Examples 22-30 and may further specify that the handlebar includes a first handle and a second handle, and the first handle and the second handle are configured to pivot about the same axis.

Example 32 may include the subject matter of any of Examples 22-31 and may further specify that the axis is either a horizontal axis or a vertical axis.

Example 33 may include the subject matter of any of Examples 22-32 and may further specify that the first handle is configured to pivot about a first axis and the second handle is configured to pivot about a second axis different from the first axis.

Various features and advantages of the invention are set forth in the following claims.

1. A system for operating a motor-driven vehicle, the system comprising:
a handlebar for steering the motor-driven vehicle, the handlebar configured to pivot about an axis;
a position sensor for sensing a displacement of the handlebar;
a first electric drive motor configured to drive a first wheel of the vehicle;
a second electric drive motor configured to drive a second wheel of the vehicle;
a first motor controller coupled to the position sensor and the first electric drive motor, the first motor controller configured to:
receive a sensed displacement of the handlebar from the position sensor; and
control the first electric drive motor based on the sensed displacement; and
a second motor controller coupled to the position sensor and the second electric drive motor, the second motor controller configured to:
receive the sensed displacement of the handlebar from the position sensor; and
control the second electric drive motor based on the sensed displacement.

2. The system of claim 1, wherein:
the first motor controller is configured to:
determine a direction for the first electric drive motor and a speed for the first electric drive motor based on the sensed displacement; and
the second motor controller is configured to:
determine a direction for the second electric drive motor and a speed for the second electric drive motor based on the sensed displacement.

3. The system of claim 2, wherein:
the position sensor is an angular position sensor; and
the sensed displacement is an angular position of the handlebar.

4. The system of claim 3, wherein:
the first motor controller is configured to:
determine an angular position band based on the angular position; and
determine the direction for the first electric drive motor and the speed for the first electric drive motor based on the angular position band; and
the second motor controller is configured to:
determine the angular position band based on the angular position; and
determine the direction for the second electric drive motor and the speed for the second electric drive motor based on the angular position band.

5. The system of claim 2, wherein:
the position sensor is a linear translation sensor; and
the sensed displacement is a linear translation of the handlebar.

6. The system of claim 5, wherein:
the first motor controller is configured to:
determine a linear translation band based on the linear translation; and
determine the direction for the first electric drive motor and the speed for the first electric drive motor based on the linear translation band; and
the second motor controller is configured to:
determine the linear translation band based on the linear translation; and
determine the direction for the second electric drive motor and the speed for the second electric drive motor based on the linear translation band.

7. The system of claim 2, further comprising:
an operational speed selector coupled to the first and second motor controllers;
wherein the first motor controller is configured to:
receive a requested speed from the operational speed selector; and
determine the speed for the first electric drive motor based on the requested speed; and
wherein the second motor controller is configured to:
receive the requested speed from the operational speed selector; and
determine the speed for the second electric drive motor based on the requested speed.

8. The system of claim 2, further comprising:
a directional selector coupled to the first and second motor controllers;
wherein the first motor controller is configured to:
receive a direction from the directional selector; and
determine the speed for the first electric drive motor and the direction for the first electric drive motor based on the direction; and
wherein the second motor controller is configured to:
receive the direction from the directional selector; and
determine the speed for the second electric drive motor and the direction for the second electric drive motor based on the direction.

9. The system of claim 1, further comprising:
a torsion controller coupled between the handlebar and a chassis of the vehicle, the torsion controller configured to bias the handlebar to a centered position relative to the axis.

10. The system of claim 1, wherein the handlebar includes a first handle and a second handle, and the first handle and the second handle are configured to pivot about the same axis.

11. The system of claim 1, wherein the axis is either a horizontal axis or a vertical axis.

12. The system of claim 1, wherein the first handle is configured to pivot about a first axis and the second handle is configured to pivot about a second axis different from the first axis.

13. A method for operating a motor-driven vehicle, the method comprising:
determining a displacement for a handlebar of the motor-driven vehicle;
controlling a first electric drive motor configured to drive a first wheel of the vehicle based on the displacement; and
controlling a second electric drive motor configured to drive a second wheel of the vehicle based on the displacement.

14. The method of claim 13, wherein:
controlling the first electric drive motor includes determining a direction for the first electric drive motor and a speed for the first electric drive motor based on the displacement; and
controlling the second electric drive motor includes determining a direction for the second electric drive motor and a speed for the second electric drive motor based on the displacement.

15. The method of claim 14, wherein determining a displacement for a handlebar of the motor-driven vehicle includes determining an angular position for the handlebar, the angular position being relative to an axis about which the handlebar is configured to pivot.

16. The method of claim 15, further comprising:
determining an angular position band based on the angular position;
determining the direction for the first electric drive motor and the speed for the first electric drive motor based on the angular position band; and
determining the direction for the second electric drive motor and the speed for the second electric drive motor based on the angular position band.

17. The method of claim 14, wherein determining a displacement for a handlebar of the motor-driven vehicle includes determining a linear translation of the handlebar.

18. The method of claim 17, further comprising:
determining a linear translation band based on the linear translation;
determining the direction for the first electric drive motor and the speed for the first electric drive motor based on the linear translation band; and
determining the direction for the second electric drive motor and the speed for the second electric drive motor based on the linear translation band.

19. The method of claim 14, further comprising:
receiving a requested speed from an operational speed selector of the vehicle;
determining the speed for the first electric drive motor based on the requested speed; and
determining the speed for the second electric drive motor based on the requested speed.

20. The method of claim 14, further comprising:
receiving a direction for the vehicle from a directional selector of the vehicle;
determining the speed for the first electric drive motor and the direction for the first electric drive motor based on the direction; and
determining the speed for the second electric drive motor and the direction for the second electric drive motor based on the direction.
